(19) United States
(12) Patent Application Publication
(10) Pub. No.: US 2010/0057435 A1
(43) Pub. Date: Mar. 4, 2010

(54) SYSTEM AND METHOD FOR SPEECH-TO-SPEECH TRANSLATION

(76) Inventors: Justin R. Kent, Mission, TX (US); Cyril Edward Roger Harris, III, Houston, TX (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 12/551,371

(22) Filed: Aug. 31, 2009

Related U.S. Application Data
(60) Provisional application No. 61/093,087, filed on Aug. 29, 2008.

(51) Int. Cl. G06F 17/28

(52) U.S. Cl. 704/3; 704/235; 704/260

(57) ABSTRACT

Disclosed herein are systems and methods for receiving an input speech sample in a first language and outputting a translated speech sample in a second language in the unique voice of a user. According to several embodiments, a translation system includes a translation mode performing the above functions and a training mode for developing a voice recognition database and a user phonetic dictionary. A speech recognition module uses a voice recognition database to recognize and transcribe the input speech samples in a first language. The text in the first language is translated to text in a second language, and a speech synthesizer develops an output speech in the unique voice of the user utilizing a user phonetic dictionary. The user phonetic dictionary may contain basic sound units, including phones, diphones, triphones, and/or words.

### RELATED APPLICATIONS

The present application claims the benefit under 35 U.S.C. §119(e) of U.S. Provisional Patent Ser. No. 61/093,087 filed Aug. 29, 2008, titled “SPEECH TO SPEECH TRANSLATOR,” which application is incorporated herein by reference in its entirety.

### TECHNICAL FIELD

This disclosure relates to systems and methods for translating speech from a first language to speech in a second language.

### BRIEF DESCRIPTION OF THE DRAWINGS

Non-limiting and non-exhaustive embodiments of the disclosure are described, including various embodiments of the disclosure with reference to the figures, in which:

FIG. 1 is a functional block diagram of a speech-to-speech translation system, according to one embodiment.

FIG. 2 illustrates an exemplary embodiment of a speech-to-speech translation system translating a phrase from English to Spanish.

FIG. 3 illustrates an exemplary embodiment of a speech-to-speech translation system initializing a user phonetic dictionary for a target language.

FIG. 4 is a list of sound units, according to one embodiment of the present disclosure.

FIG. 5 is a master phonetic dictionary, according to one embodiment.

FIG. 6 is a user phonetic dictionary, according to one embodiment.

FIG. 7 illustrates use of the list of sound units and master phonetic dictionary to initialize the user phonetic dictionary, according to one embodiment.

FIG. 8 illustrates how speech recognition may occur.

FIG. 9 illustrates how machine translation may occur.

FIG. 10 illustrates how speech synthesis may occur.

FIG. 11 illustrates a flow diagram or an embodiment of a method for voice recognition.

FIG. 12 illustrates a flow diagram of an embodiment of a method for speech synthesis.

FIG. 13 illustrates a flow diagram of an exemplary method for translating speech from a first language to a second language and for building a voice recognition database and/or initializing and augmenting a user phonetic dictionary.

FIG. 14 illustrates an exemplary method for selecting an input and/or output language, for translating speech from a first language to a second language, and for building a voice recognition database and/or initializing and augmenting a user phonetic dictionary.

### DETAILED DESCRIPTION

In the present period of increasing globalization, there is an increasing demand for speech-to-speech translation systems, or devices that can translate and output audible speech simply by speaking into them. A speech-to-speech translation system (also referred to herein as a speech-to-speech translator) may receive input speech from a user and generate an audible translation in another language. The system may be configured to receive input speech in a first language and automatically generate an audible output speech in one or more languages.

The status quo of speech-to-speech translators is to simply translate the words of a first original language into a second different language. For example, a speech-to-speech translator may translate a user's message spoken in a first language into the second language and output the translated message in the second language using a generic voice. While this is an astounding feat, there are additional aspects to translation beyond simply converting words into different language. For example, there is also the person behind those words, including that person's unique voice. Yet, there are not any speech-to-speech translators that can output the original speaker's voice in the translated language. The output of such a translator may sound like the original speaker speaking in the different language.

The present disclosure contemplates systems and methods that can enhance communication via translation by transmitting the sense that the user is actually talking in the translated language, rather than just a machine doing the talking. This is achieved by storing basic sound units of a language, spoken in the user's voice, and accessing those basic sound units when giving voice to a translated message or utterance (i.e. producing output speech).

A speech-to-speech translation system according to one embodiment of the present disclosure may comprise a speech recognition module, a machine translation module, and a speech synthesis module. Advanced technologies, such as automatic speech recognition, speech-to-text conversion, machine translation, text-to-speech synthesis, natural language processing, and other related technologies may be integrated to facilitate the translation of speech. Moreover, a user interface may be provided to facilitate the translation of speech.

The speech recognition module may receive input speech (i.e. a speech signal) from a user via a microphone, recognize the source language, and convert the input speech into text in the source language. The machine translation module may translate the text in the source language to text in a target language. The speech synthesis module may synthesize the text in the target language to produce output speech in the target language. More particularly, the speech synthesis module may utilize basic sound units spoken by the user to construct audible output speech that resembles human speech spoken in the user's voice. The term “resembles” as used herein is used to describe a synthesized voice as being exactly like or substantially similar to the voice of the user; i.e. the synthesized voice sounds exactly like or substantially similar to the voice of the user, such that an audience hearing the synthesized voice could recognize the user (speaker).

The basic sound units utilized by the speech synthesis module may comprise basic units of speech and/or words that are frequently spoken in the language. Basic units of speech include but are not limited to: basic acoustic units, referred to as phonemes or phones (a phoneme, or phone, is the smallest phonetic unit in a language); diphones (units that begin in the middle of a stable state of a phone and end in the middle of the following one); half-syllables; and triphones (units similar to diphones but including a central phone). Collectively, the phones, diphones, half-syllables, triphones, frequently used words, and other related phonetic units are referred to herein as “basic sound units.”

The speech synthesis module may utilize a phonetic-based text to speech synthesis algorithm to convert input text to speech. The phonetic based text-to-speech synthesis algorithm may consult a pronunciation dictionary to identify basic sound units corresponding to input text in a given language. The text-to-speech synthesis algorithm may have access to a phonetic dictionary or database containing various possible basic sound units of a particular language. For example, for the text “Hello,” a pronunciation dictionary may indicate a phonetic pronunciation as ‘he-loh’, where the ‘he’ and the ‘loh’ are each basic sound units. A phonetic dictionary may contain audio sounds corresponding to each of these basic sound units. By combining the ‘he’ and the ‘loh’ within the phonetic dictionary, the speech synthesis module may adequately synthesize the text “hello” into an audible output speech resembling that of a human speaker. By using basic sound units spoken in the voice of the user, the speech synthesis module can synthesize the input text into audible output speech resembling the voice of the user.

An exemplary embodiment of a speech synthesis module, according to the present disclosure, may utilize a user-specific phonetic dictionary to produce output speech in the unique voice of the user. Thus, a user may be able to speak in a first language into the speech-to-speech translation system and the system may be configured to produce output speech in a second language that is spoken in a voice resembling the unique voice of the user, even though the user may be unfamiliar with the second language.

The present disclosure contemplates the capability to process a variety of data types, including both digital and analog information. The system may be configured to receive input speech in a first or source language, convert the input speech to text, translate the text in the source language to text in a second or target language, and finally synthesize the text in the target language to output speech in the target language spoken in a voice that resembles the unique voice of the user.

To achieve synthesis of output speech spoken in a voice resembling that of a user speaking in the target language, the present disclosure also contemplates initializing and/or developing (i.e. augmenting) a user phonetic dictionary that is specific to the user. According to one embodiment, a user dictionary initialization module may initialize and/or develop user phonetic dictionaries in one or more target languages. The user dictionary initialization module may facilitate the user inputting all the possible basic sound units for a target language. A user dictionary initialization module building a database of basic sound units may receive input speech from a user. The input speech may comprise natural language speech of the user and/or a predetermined set of basic sounds, including but not limited to phones, diphones, half-syllables, triphones, frequently used words. The user dictionary initialization module may extract basic sound units from the input speech sample, and store the basic sound units in an appropriate user phonetic dictionary. Accordingly, user phonetic dictionaries may be initialized and/or developed to contain various basic sound units for a given language.

According to another embodiment, a speech-to-speech translation module may comprise a training module for augmenting speech recognition (SR) databases and/or voice recognition (VR) databases. The training module may also facilitate initializing and/or developing user phonetic dictionary. The training module may request that a user provide input speech comprising a predetermined set of basic sound units. The training module may receive the input speech from the user, including the predetermined set of basic sound units, spoken into an input device. The training module may extract one or more basic sound units from the input speech and compare the one or more extracted basic sound units to a predetermined speech template for the predetermined set of basic sound units. The training module may then store the one or more extracted basic sound units in a user phonetic dictionary if they are consistent with the speech template.

The training module may also augment speech recognition (SR) databases to improve speech recognition. According to various embodiments, a SR module recognizes and transcribes input speech provided by a user. A SR template database may contain information regarding how various basic sound units, words, or phrases are typically enunciated. To augment a SR template database, the training module may request input speech from one or more users corresponding to known words or phrases and compare and/or contrast the manner those words or phrases are spoken by the one or more users with the information in the SR template database. The training module may generate an SR template from the input speech and add the SR templates to a SR template database.

The SR module may comprise a VR module to recognize a specific user based on the manner that the user enunciates words and phrases and/or based on the user's voice (i.e. speaker recognition as compared to simply speech recognition). A VR template database may contain information regarding voice characteristics of various users. The VR module may utilize the VR template database to identify a particular user, and thereby aid the SR module in utilizing appropriate databases to recognize a user's speech. Moreover, the VR module may enable a single device to be used by multiple users. According to one embodiment, to augment a user specific VR template database, the system requests an input speech sample from a user corresponding to known words or phrases. The system may generate a VR template from the input speech and add the VR template to a VR template database. The VR module may utilize information within the VR template database to accurately recognize particular users and to recognize and transcribe input speech.

According to still another embodiment, a user may be enabled to select from a variety of voice types for an output speech. One possible voice type may be the user's unique voice. Another possible voice type may be a generic voice.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture (such as a computer readable storage medium), a method, and a product of a process.

The phrases “connected to,” and “in communication with” refer to any form of interaction between two or more entities, including mechanical, electrical, magnetic, and electromagnetic interaction. Two components may be connected to each other even though they are not in direct contact with each other and even though there may be intermediary devices between the two components.

Much of the infrastructure that can be used with embodiments disclosed herein is already available, such as: general-purpose computers; computer programming tools and techniques; and digital storage media. A computer may include a processor, such as a microprocessor, microcontroller, logic circuitry, or the like. The processor may include a special purpose processing device, such as an ASIC, PAL, PLA, PLD, Field Programmable Gate Array, or other customized or programmable device. The computer may also include a computer readable storage device, such as non-volatile memory, static RAM, dynamic RAM, ROM, CD-ROM, disk, tape, magnetic, optical, flash memory, or other computer readable storage medium

Aspects of certain embodiments described herein are illustrated as software modules or components. As used herein, a software module or component may include any type of computer instruction or computer executable code located within a computer readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a computer readable storage medium, which together implement the described functionality of the module. Indeed, a module may comprise a single instruction or many instructions, and may be distributed over several different code segments, among different programs, and across several computer readable storage media. Some embodiments may be practiced in a distributed computing environment where tasks are performed by a remote processing device linked through a communications network. In a distributed computing environment, software modules may be located in local and/or remote computer readable storage media. In addition, data being tied or rendered together in a database record may be resident in the same computer readable storage medium, or across several computer readable storage media, and may be linked together in fields of a record in a database across a network.

The software modules described herein tangibly embody a program, functions, and/or instructions that are executable by computer(s) to perform tasks as described herein. Suitable software, as applicable, may be readily provided by those of skill in the pertinent art(s) using the teachings presented herein and programming languages and tools, such as XML, Java, Pascal, C++, C, database languages, APIs, SDKs, assembly, firmware, microcode, and/or other languages and tools.

Furthermore, the described features, operations, or characteristics may be combined in any suitable manner in one or more embodiments. It will also be readily understood that the order of the steps or actions of the methods described in connection with the embodiments disclosed herein may be changed as would be apparent to those skilled in the art. Thus, any order in the drawings or detailed description is for illustrative purposes only and is not meant to imply a required order, unless specified to require an order.

In the following description, numerous details are provided to give a thorough understanding of various embodiments disclosed herein. One skilled in the relevant art will recognize, however, that the embodiments disclosed herein can be practiced without one or more of the specific details, or with other methods, components, materials, etc. In other instances, well-known structures, materials, or operations are not shown or described in detail to avoid obscuring aspects of this disclosure. Furthermore, the described features, structures, or characteristics may be combined in any suitable manner in one or more alternative embodiments.

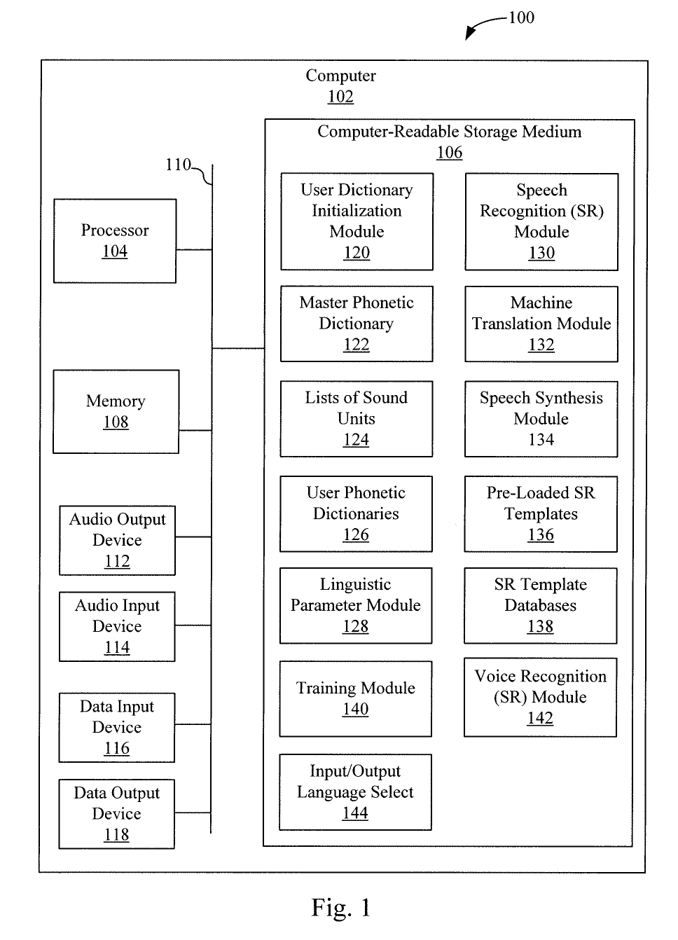

FIG. 1 is a speech-to-speech translation system 100, according to one embodiment of the present disclosure. The system 100 may be utilized to provide output speech in a target language corresponding to input speech provided in a source language. The system 100 may comprise a computer 102 that includes a processor 104, a computer-readable storage medium 106, Random Access Memory (memory) 108, and a bus 110. An ordinarily skilled artisan will appreciate that the computer may comprise a personal computer (PC), or may comprise a mobile device such as a laptop, cell phone, smart phone, personal digital assistant (PDA), or a pocket PC. The system 100 may comprise an audio output device 112 such as a speaker for outputting audio and an input device 114 such as a microphone for receiving audio, including input speech in the form of spoken or voiced utterances. Alternatively, the speaker and microphone may be replaced by corresponding digital or analog inputs and outputs; accordingly, another system or apparatus may perform the functions of receiving and/or outputting audio signals. The system 100 may further comprise a data input device 116 such as a keyboard and/or mouse to accept data input from a user. The system 100 may also comprise a data output device 118 such as a display monitor to present data to the user. The data output device may enable presentation of a user interface to a user.

The bus 110 may provides a connection between memory 108, processor 104, and computer-readable storage medium 106. Processor 104 may be embodied as a general-purpose processor, an application specific processor, a microcontroller, a digital signal processor, or other device known in the art. Processor 104 may perform logical and arithmetic operations based on program code stored within computer-readable storage medium 106.

Computer-readable storage medium 106 may comprise various modules for converting speech in a source language (also referred to herein as first language or L1) to speech in a target language (also referred to herein as a second language or L2). Exemplary modules may include a user dictionary initialization module 120, a master phonetic dictionary 122, lists of sound units 124, user phonetic dictionaries 126, a linguistic parameter module 128, a speech recognition (SR) module 130, a machine translation (text-to-text) module 132, a speech synthesis module 134, pre-loaded SR templates 136, SR template databases 138, a training module 140, a voice recognition (VR) module 142, and/or an input/output language select 144. Each module may perform or be utilized during one or more tasks associated with speech-to-speech translation, according to the present disclosure. One of skill in the art will recognize that certain embodiments may utilize more or fewer modules than are shown in FIG. 1, or alternatively combine multiple modules into a single module.

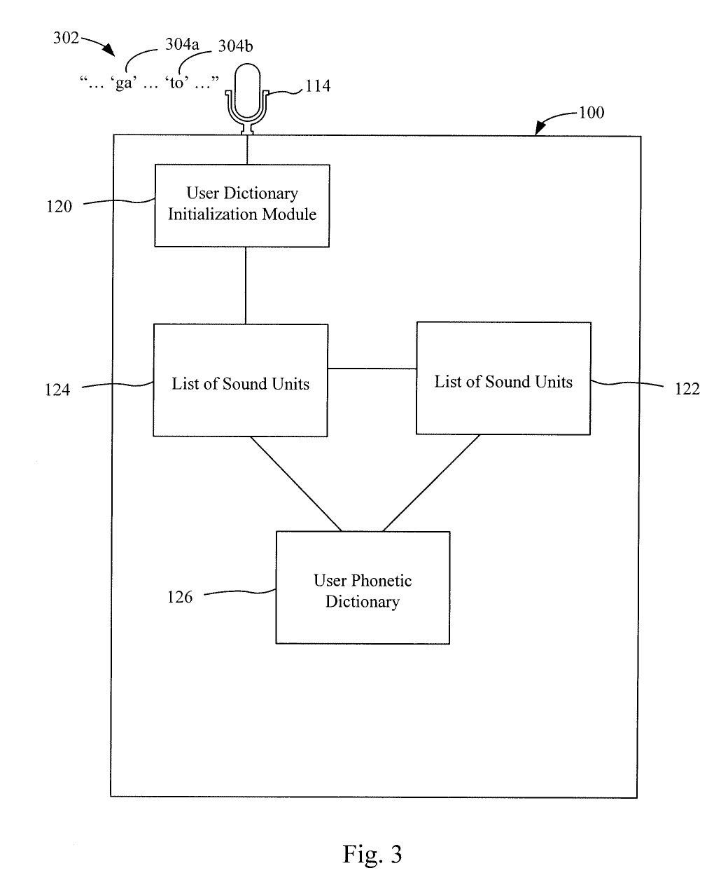

In various embodiments, the modules illustrated in FIG. 1 may be configured to implement the steps and methods described below with reference to FIGS. 3-14. For example, the user dictionary initialization module 120 may be configured to receive input speech from a user, extract basic sound units based on the master phonetic dictionary 122 and the lists of sounds 124, and initialize or augment the user phonetic dictionaries 126. The SR module 130 may be configured to transcribe input speech utilizing SR template databases 138. The machine translation (text-to-text) module 132 may be configured to translate text from a source language to text in a target language, for which both the languages may be selected the via input/output language select 144. Ultimately, translated text may be synthesized within the speech synthesis module 134 into output speech. Speech synthesis module 134 may utilize user phonetic dictionaries 126 to produce audible output speech in the unique voice of a user. Additionally, machine translation module 132 and speech synthesis module 134 may utilize the linguistic parameter module 128 to develop flow, grammar, and prosody of output speech. The input/output language select 144 may be configured to allow a user to select a source language and/or a target language. The training module 140 may be configured to request input speech according to the pre-loaded SR templates 136 and receive and process the input speech to augment the SR template databases 138. Additionally, the training module 140 may be configured to request input speech according to the master phonetic dictionary 122 and/or the lists of sound units 124, and receive and process input speech to augment the user phonetic dictionaries 126.

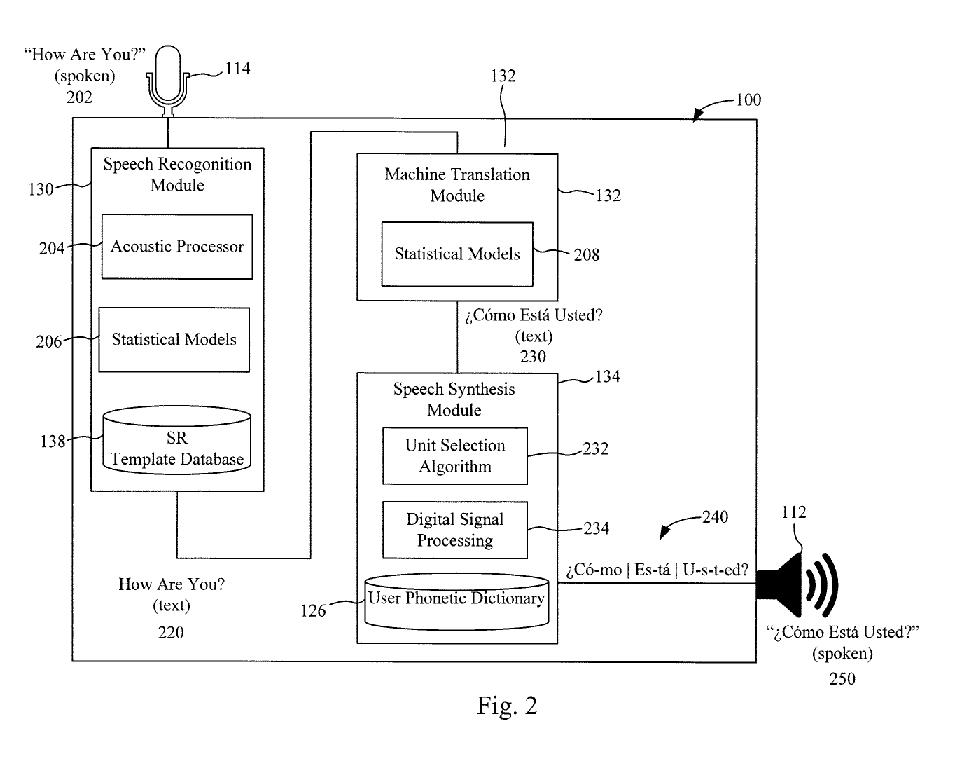

FIG. 2 illustrates an exemplary embodiment of a speech-to-speech translation system 200 translating the phrase “How Are You?” spoken by a user in English (source language L1) into Spanish (target language L2) spoken by the translation system in a manner resembling the voice of the user. The input speech 202, in this case the phrase “How Are You?”, is received by the system 100 via a microphone 114.

The SR module 130 receives the input speech 202 and may utilize an internal acoustic processor 204, statistical models 206, and/or the SR template database 138 to identify words contained in the input speech 202 and otherwise recognize the input speech 202. According to one embodiment, the SR module 130 may also utilize context based syntactic, pragmatic, and/or semantic rules (not shown). The SR module 130 transcribes and converts input speech 202 to source language text 220. Alternatively, the SR module 130 may convert input speech 202 to a machine representation of the text.

The source language text 220 “How Are You?” is translated by the machine translation module 132 from the source language L1 to target language text 230 in a target language L2. The machine translation module 132 takes as input text of the input speech in the source language. The machine translation module 132 decodes the meaning of the text and may use statistical models 208 to compute the best possible translation of that text into the target language. The machine translation module 132 may utilize various linguistic parameter databases to develop correct grammar, spelling, enunciation guides, and/or translations. As illustrated, the target language text 230 is in Spanish; however, according to alternative embodiments, the target language may be a language other than Spanish. Moreover, the user may be able to select input and/or output languages from a variety of possible languages using the input/output language select 144 (FIG. 1). The Spanish phrase, “ [symbol] Cómo Está Usted?,” is the Spanish translation of the source language text 220 “How Are You?” Accordingly, the target language text 230 “ [symbol] Cómo Está Usted?”, is passed on to speech synthesis module 134.

Speech synthesis module 134 receives the target language text 230 and may utilize algorithms such as the unit selection algorithm 232 and/or natural language processing algorithms (not shown), digital signal processing 234, and the user phonetic dictionary 126 to develop output speech of the phrase in Spanish. According to one embodiment of the present system and method, speech synthesis module 134 utilizes basic sound units stored within the user phonetic dictionary 126 to audibly construct the Spanish text phrase. In other words, the Spanish phrase “ [symbol] Cómo Está Usted?” is constructed of the basic sound units 240 “ [symbol] Cómo Está Usted?” (each basic sound unit is separated by a “-” and each word is separated by a “|”). Each of the basic sound units 240 may correspond to a stored phone, diphone, triphone, or word within user phonetic dictionary 126.

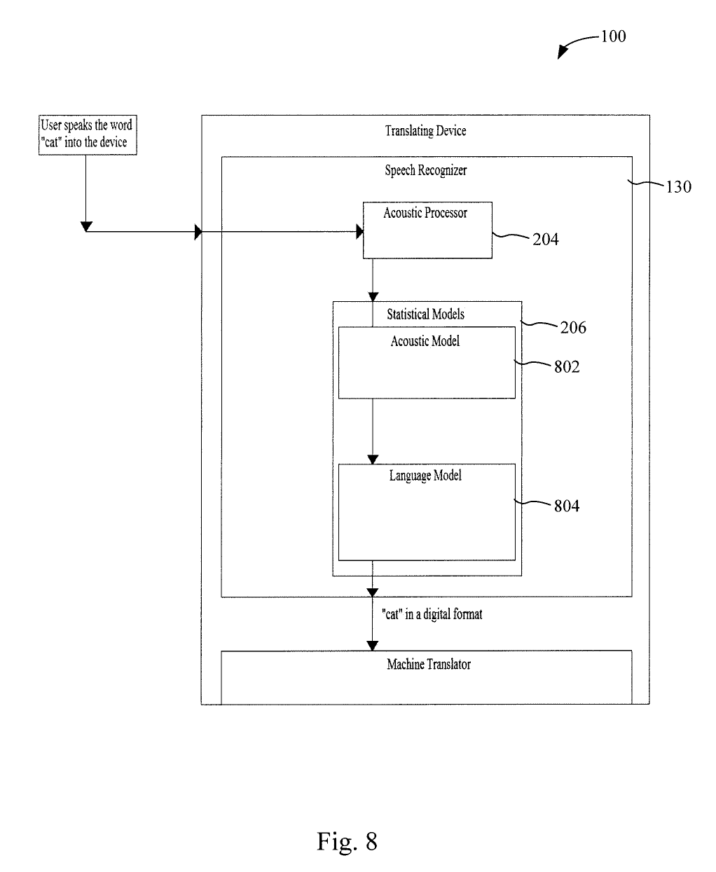

By utilizing the user phonetic dictionary 126 developed by a user of system 100, the output speech 250 “ [symbol] Cómo Está Usted?” may be spoken by the system 100 in the unique voice of the user. Following synthesis of the Spanish text, the speaker 112 emits the output speech “ [symbol] Cómo Está Usted?” 250 in the unique voice of the user. Thus, while an original user who provided the input speech “How Are You?” 202 may not speak Spanish, the output speech “ [symbol] Cómo Está Usted?” 25 may be enunciated by system 100 in synthesized voice that resembles the voice of the user. Speech-to-speech translation according to the present disclosure is discussed in greater detail below with reference to FIGS. 8-10.

FIG. 3 illustrates an exemplary embodiment of speech-to-speech translation system 100 initializing a user phonetic dictionary 126 for a target language. Before output speech can be synthesized in a voice that resembles the voice of a user, at least a portion of a user phonetic dictionary 126 must be initialized. To initialize the user phonetic dictionary 126, a user provides, to the system, input speech 302 comprising basic sound units 304a,b of the target language. The basic sound units 304a,b are extracted and stored in the list of sound units 124, thereby initializing the list of sound units 124. The basic sound units are recorded in the voice of the user. For example, the Spanish language may be selected via a user interface, and the user would input the basic sound units that are inherent to the Spanish language. The list of sound units 124 is then used with the master phonetic dictionary 122 to combine the basic sound units for each word of the target language and store the combination for each word in the user phonetic dictionary 126, and thereby initialize the user phonetic dictionary 126.

The initialization of the user phonetic dictionary will now be explained with greater detail with reference to FIGS. 3 through 7. Input speech 302 is received by the system 100 via the microphone 114. The input speech 302 includes basic sound units 304a,b of the target language, in this case Spanish. In the illustrated example, the input speech comprises Spanish basic sound unit “ga” 304a (the ‘a’ is pronounced like in hat) and basic sound unit “to” 304b (the ‘o’ is pronounced like in go). The user dictionary initialization module 120 receives the input speech 302 and extracts basic sound units 304a,b that are included in the input speech. The user dictionary initialization module 120 may identify the basic sound units 304a,b based on the list of sound units 124.

There are at least three different ways by which the system 100 can obtain the basic sound units as input speech from the user. First, the user may pronounce each sound unit of the target language individually. The user need not actually pronounce words in the target language, but rather may simply pronounce the basic sound units that are found in the target language. For example, the user may pronounce the basic sound units “ga” and “to.” Second, the user may read text or otherwise pronounce words in the target language. For example, the user may speak a phrase or sentence in Spanish containing the word “gato.” The user dictionary initialization module 120 may extract from the word “gato” the basic sound units “ga” and “to.” This method may be effective where the user has some minimal familiarity with the target language, but simply is not proficient and thus requires translation. Third, the user may read text or otherwise pronounce words in the source language that contain the basic sound units of the target language. For example, the user may speak in English (i.e. the source language of this example) a phrase or sentence containing the words “gadget” and “tomato.” The user dictionary initialization module 120 may extract the basic sound unit “ga” from the word “gadget” and may extract to basic sound unit “to” from the word tomato. This method may be effective for users who have no familiarity or understanding of the target language or the basic sound units of the target language.

A user interface may be presented to the user to prompt the user as to the input needed. For example, if the first method is employed, the user interface may present a listing of all the basic sound units of the target language. If the second method is employed, the user interface may present words, phrases, and/or sentences of text in the target language for the user to read. The user interface may also provide an audio recording of the words, phrases, and/or sentences for the user to listen to and then mimic. If the third method is employed, the user interface may present the words for the user to say; e.g. “gadget” and “tomato”.

The user dictionary initialization module 120 may employ aspects of the SR module and/or VR module and SR template databases and/or VR template databases to extract basic sound units from the input speech.

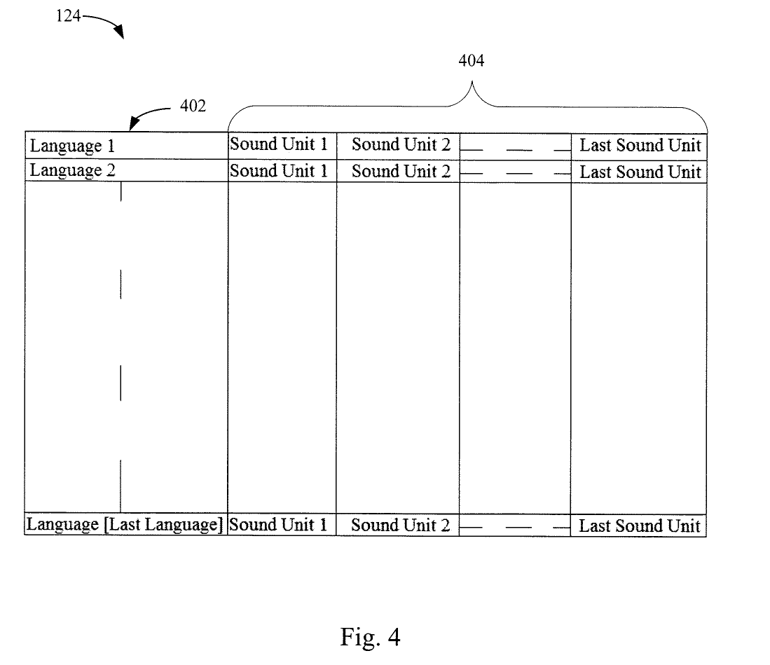

FIG. 4 is a list of sound units 124, according to one embodiment of the present disclosure. The list of sounds 124 may contain a listing of all the basic sound units 404 for one or more languages 402, including the target language, and provide space to store a recording of each basic sound unit spoken in the voice of the user. The user dictionary initialization module 120 may identify gaps in the list of sounds; i.e. a basic sound unit without an associated recording of that basic sound unit spoken in the voice of the user. The listing of all the basic sound units 404 in the list of sound units 124 may be compiled from the master phonetic dictionary 122. As will be appreciated, the list of sound units 124 may provide many variations of the same basic sound unit in order to provide options for a speech synthesis module.

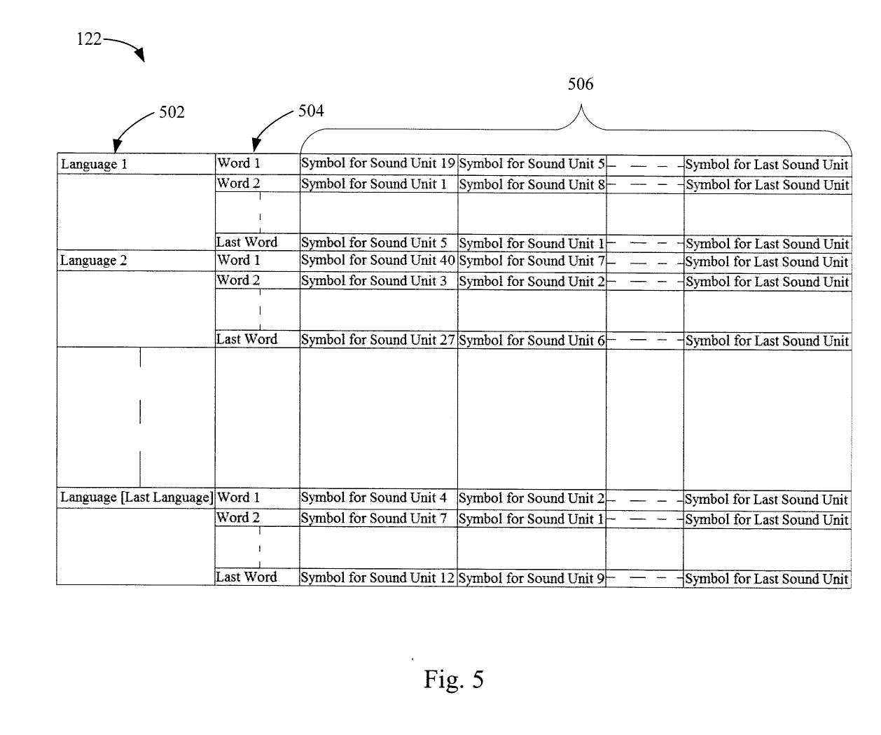

FIG. 5 is a master phonetic dictionary 122, according to one embodiment of the present disclosure. The master phonetic dictionary 122 may contain a listing of all the words 504 of one or more languages 502, including the target language. The master phonetic dictionary 122 may further contain a list of symbols 506 for all the basic sound units of each of the words 504. The list of symbols 506 may be indicated in the order in which the basic sound units would be spoken (or played from a recording) to pronounce the word. The number of sound units for each word may vary.

Because the master phonetic dictionary contains all the words 504 of a given language 502 and symbols for all the basic sound units 506 for each word 504, the lists of symbols 506 for all the words 504 can by combined and filtered to provide a listing of all the basic sound units for a given language. The listing of basic sound units can be included in the list of sound units as previously described.

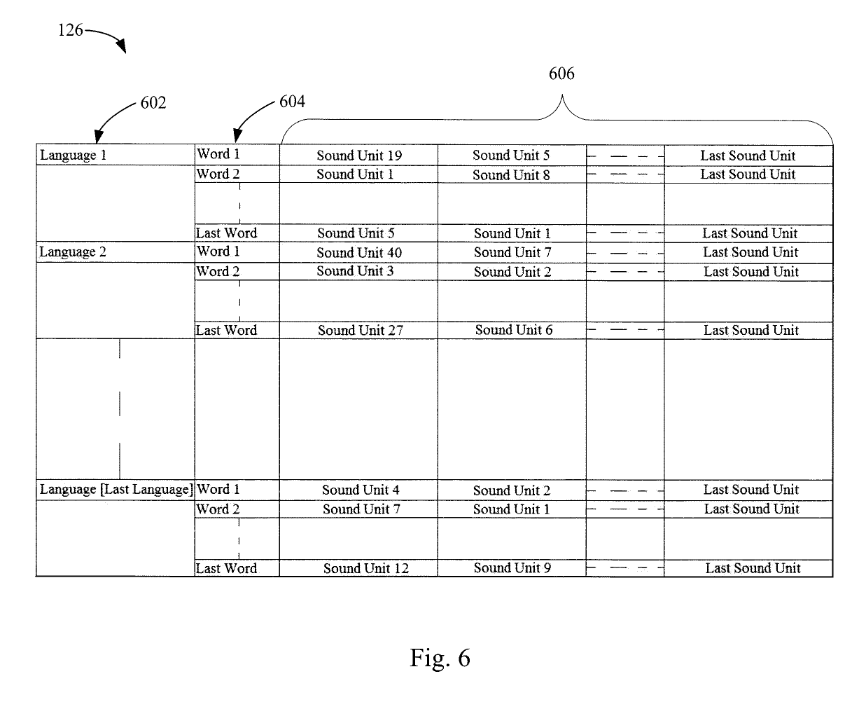

FIG. 6 is a user phonetic dictionary 126, according to one embodiment of the present disclosure. The user phonetic dictionary 126 includes a listing of all the words 604 of one or more languages 606, similar to the master phonetic dictionary 122. Instead of the symbols of basic sound units, as are contained in the master phonetic dictionary 122, the user phonetic dictionary 126 contains the recordings of the basic sound units as stored in the list of sound units 124. The recordings of the basic sound units for each word are stored in association with each word when the user phonetic dictionary 126 is initialized. Accordingly, when audio corresponding to target language text is provided from the user phonetic dictionary 126 to a speech synthesis module to synthesize a voice speaking the target language, the synthesized voice resembles the voice of the user.

Preferably the user would provide input speech for all of the possible sound units that are inherent to the target language, to thereby enable complete initialization of the user phonetic dictionary 126. However, an ordinarily skilled artisan will appreciate that the list of sound units may initially be populated by recordings of basic sound units spoken by a generic voice, and accordingly the user phonetic dictionary 126 may initially be initialized with recordings of basic units spoken by a generic voice. As recordings of basic sound units spoken by the user are obtained, they can replace the basic sound units spoken in the generic voice in the list of sound units 124. As the list of sound units 124 are received, portions of the user phonetic dictionary 126 can be re-initialized (or developed or augmented as these terms are used synonymously elsewhere herein).

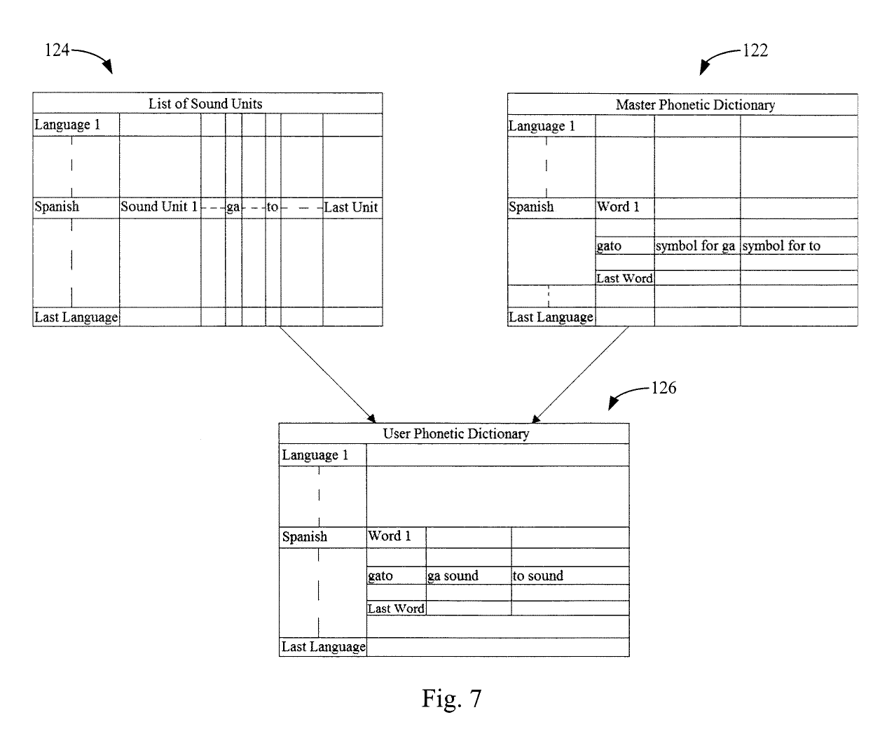

FIG. 7 illustrates use of the list of sound units 124 and master phonetic dictionary 122 to initialize the user phonetic dictionary 126. Upon initialization of the list of sound units 124, available recordings of the basic sound units stored therein can be combined to initialize the user phonetic dictionary 126. Each word for a given target language in the master phonetic dictionary 122 may be stored in the user phonetic dictionary 126 to provide a listing of all the words of the target language. The symbol for each basic unit sound for each word of the target language is then used to identify the appropriate recording of the basic unit as stored in the list of sound units 124. The user phonetic dictionary 126 can store, in connection with each word of the target language, the recordings of the basic sound units that are stored in list of sound units 124 for each basic sound unit in the word.

Continuing with the example presented with reference to FIG. 3, the basic sound unit “ga” 304a and the basic sound unit “to” 304b are extracted from the input speech 302 and stored in the list of sound units 124 in connection with the language Spanish. The master phonetic dictionary 122 indicates that the language Spanish includes the word “gato” and that the basic sound units of the word gato include the basic sound unit “ga” 304a and the basic sound unit “to.” In the user phonetic dictionary 126, the word “gato” is initialized with recordings of the basic sound unit “ga” 304a and basic sound unit “to” 304b. Stated differently, recordings of the basic sound unit “ga” 304a and basic sound unit “to” 304b are stored in the user phonetic dictionary 126 in association with the entry for the word “gato.”

As mentioned, an efficient method of initialization would receive all of the basic sound units for a given language and store them into the list of sounds 124 to enable complete initialization of the user phonetic dictionary 126. However, various modes and methods of partial initialization may be possible. One example may be to identify each word 504 in the master phonetic dictionary 122 for which all the symbols of the basic sound units 506 have corresponding recordings of the basic sound units stored in the list of sounds 124. For each such identified word, the entry for that word in the user phonetic dictionary 126 may be initialized using the recordings for the basic sound units for that word.

With the User Phonetic Dictionary initialized with respect to the word “gato,” including the basic sound units “ga” and “to,” the user can perform speech-to-speech translation of “cat” into “gato”. As previously described the system may accomplish translation in three stages and/or using three modules: Speech Recognition, Machine Translation and Speech Synthesis. FIG. 8 illustrates the speech recognition module 130 and shows how speech recognition may occur. The user may speak the word “cat” into the system 100. The speech recognition module 130 may use a built in acoustic processor 204 to process and prepare the user's speech in the form of sound waves to be analyzed. The speech recognition module 130 may then input the processed speech into statistical models 204, including acoustic models 802 and language models 804, to compute the most probable word(s) that the user just spoke. In this example the word “cat” in digital format is computed to be the most probable word and is outputted from the speech recognition module 130.

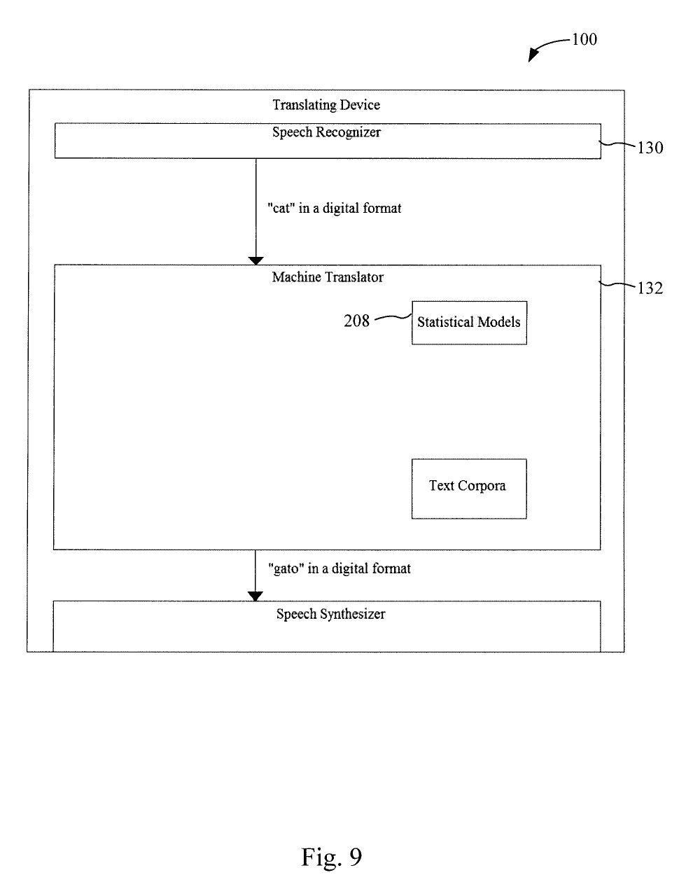

FIG. 9 illustrates the machine translation module 132 and shows how machine translation may occur. The machine translation module 132 may take as input the output from the speech recognition module 130, which in this instance is the word “cat” in a digital format. The machine translation module 132 may take as input “cat” in the source language L1, which in this example is English. The machine translation module 132 may decode the meaning of the message, and using statistical models, compute the best possible translation of that message into the target language L2, which in this example is Spanish. For this example, the best possible translation of that message is the word “gato”. “Gato” in digital format may be outputted from the machine translation module 132.

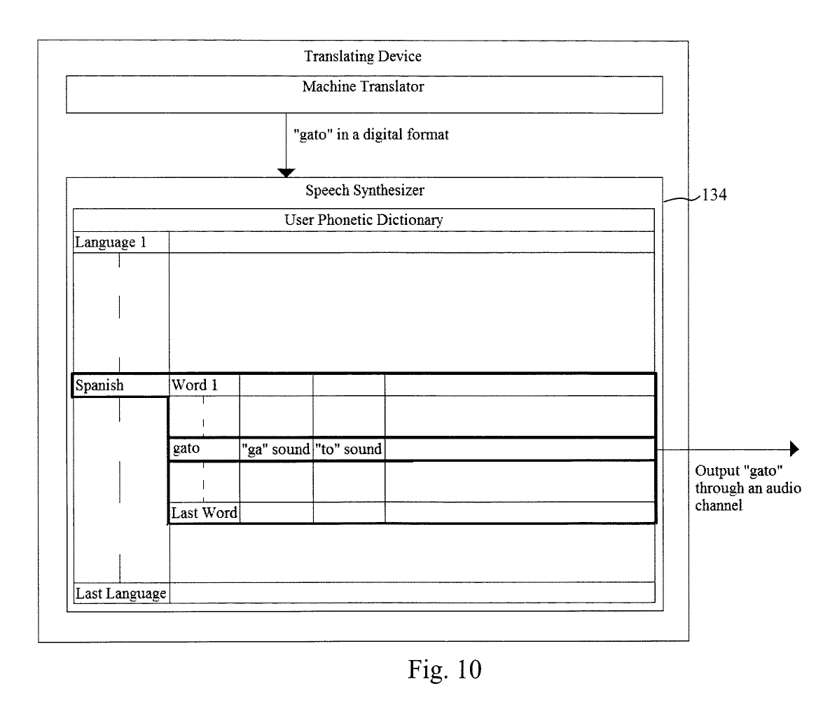

FIG. 10 illustrates the speech synthesis module 134 and shows how speech synthesis may occur. When “gato” is passed to the speech synthesis module 134, the speech synthesis module 134 may use algorithms such as the unit selection algorithm (shown in FIG. 2) to prepare audio to be outputted. The unit selection algorithm may access the user phonetic dictionary 126 and output the “ga” sound followed by the “to” sound that are found in this dictionary. The word “gato” is outputted through the audio output device of the system. Because the user personally spoke the sounds in the User Phonetic Dictionary, the output of “gato” may sound as if the user himself spoke it.

In summary, the device may recognize the words the user is speaking in language L1 (Speech Recognition), translate the meaning of those words from L1 to L2 (Machine Translation), and synthesize the words of L2 using the User's Phonetic Dictionary and not a generic phonetic dictionary (Speech Synthesis). The speech-to-speech translator may provide users with the ability to communicate (in real time) their voice in a foreign language without necessarily having to learn that language. By using recordings of the user pronouncing sounds in another language, the system may provide a means to communicate on that level of personalization and convenience.

Additional details as to how Speech-to-Speech Translation takes place will now be provided.

The first stage of speech-to-speech translation is speech recognition. A speech recognition module (or Speech Recognizer) may take as input the user's voice and output the most probable word or group of words that the user just spoke. More formally, the purpose of a Speech Recognizer is to find the most likely word string Ŵ for a language given a series of acoustic sound waves O that were input into it. This can be formally written with the following equation:

$$\hat{W} = {arg max}_{W ∈ L} P ( O \vert W ) P ( W ) \qquad [ 1.1 ]$$

Where W is a word sequence w₁, w₂, w₃, . . . , wₙ coming from a specific language L and O is a sequence of acoustic evidence o₁, o₂, o₃, . . . , oₜ. Equation 1.1 can be thought of as: find the W that maximizes P(O|W)*P(W), where P(W) is the probability that a word sequence occurred and P(O|W) is the probability that that a specific set of acoustic evidence O has occurred given that the specific Word sequence W has occurred. The W that maximizes this probability is Ŵ.

As the speech is input into the Speech Recognizer it must first be processed by an Acoustic Processor. The Acoustic Processor may prepare the sound waves to be processed by the statistical models found in the Speech Recognizer, namely the Acoustic and Language Models. Here the Acoustic Processor may sample and parse the speech into frames. These frames are then transformed into spectral feature vectors. These vectors represent the spectral information of the speech sample for that frame. For all practical purposes, these vectors are the observations that the Acoustic Model is going to be dealing with.

Referring to equation 1.1, the purpose of the Acoustic Model is to provide accurate computations of P(O|W). This probability may be known as the observation likelihood. Hidden Markov Models, Gaussian Mixture Models, and Artificial Neural Networks are used to compute these probabilities. Application of Hidden Markov Models are discussed in greater detail below.

Referring again to equation 1.1, the purpose of the Language Model is provide accurate computations of P(W). P(W) can be expanded as the following equation:

P(wₙ|w₁,w₂, . . . , wₙ₋₁) [1.2]

Equation 1.2 can be read as the probability of the word wₙ occurring given that the previous wₙ₋₁ words have already occurred. This probability is known as the prior probability and is computed by the Language Model. Smoothing Algorithms may be used to smooth out these probabilities. The primary algorithms used for smoothing may be the Good-Turing Smoothing, Interpolation, and Back-off Methods.

Once to most probable Ŵ has been computed in the input language L1, it may be sent to a machine translation module 132 (or Machine Translator). The second stage of Speech-to-Speech Translation is Machine Translation. The Machine Translator may translate Ŵ from its original input language L1, into L2, the language that the speech may be outputted in. The Machine Translator may use Rule-based, Statistical, and Example Based approaches for the translation process. Also, this invention is capable of using Hybrid approaches of translation as well. The output of the Machine Translation stage may be text in L2 that accurately represents the original text in L1.

The third stage of Speech-to-Speech Translation is Speech Synthesis. It is during this stage that the text in language L2 is outputted via an audio output device (or other audio channel). This output may be acoustic waveforms. This stage has two phases: (1) Text Analysis and (2) Waveform Synthesis. The Text Analysis phase may use Text Normalization, Phonetic Analysis, and Prosodic Analysis to prepare the text to be synthesized during the Waveform Synthesis phase. The primary algorithm to be used to perform the actual synthesis is the Unit Selection Algorithm. This algorithm may use the sound units stored in the User Phonetic Dictionary to perform Speech Synthesis. The synthesized speech is outputted via an audio channel.

Hidden Markov Models (HMMs) are an integral part to Speech-to-Speech Translation. HMMs will now be described in details and explanation provided for how they may be used to accomplish the tasks found in the translation process.

Hidden Markov Models are statistical models that are used in Machine Learning to compute the most probable hidden events that are responsible for seen observations. HMMs are a crucial part of this device's processes because words may primarily be represented through HMMs. The following is a formal definition of Hidden Markov Models:

A Hidden Markov Model is defined by five properties: (Q, 0, V, A, B).

Q may be a set of N hidden states. Each state emits symbols from a vocabulary V. Listed as a string they would be seen as: q₁, q₂, . . . , qₙ. Among these states there is a subset of start and end states. These states define which states can start and end a string of hidden states

O is a sequence of T observation symbols drawn from a vocabulary V. Listed as a string they would be seen as o₁, o₂, . . . , o_{T}.

V is a vocabulary of all symbols that can be emitted by a hidden state. Its size is M.

A is a transition probability matrix. It defines the probabilities of transitioning to each state when the HMM is in each particular hidden state. Its size is N×N.

B is a emission probability matrix. It defines the probabilities of emitting every symbol from V for each state. Its size is N×M.

A Hidden Markov Model can be thought of as operating as follows. At every time it operates in a hidden state it decides upon two things: (1) which symbol(s) to emit from a vocabulary of symbols, (2) which state to transition to next from a set of possible hidden states. What determines how probable a HMM may emit symbols and transition to other states is based on the parameters of the HMM, namely the A and B matrices.

Many words, word forms, and other parts of a language may be represented by means of Hidden Markov Models. This systems and methods disclosed herein may at multiple stages encounter the following inherent problems to HMMs. The following may describe these problems and the accompanying algorithms that are used to solve these problems.

[1] Learning. Given an observation sequence O and the set of states Q, learn the most probable values for the transition probability matrix A, and the emission probability matrix B of the HMM A.

[2] Decoding. Given an HMM A with its observation sequence O, compute the most probable hidden state sequence Q that the HMM was in for each observation.

[3] Likelihood. Given an HMM A, with an observation sequence O generated by A, determine the likelihood P(O|A).

Solving Problem [3] Likelihood:

The forward algorithm is used by this invention to solve problem [3], the Likelihood problem for HMMs. It is a dynamic programming algorithm that uses a table of probabilities also known as a trellis to store all probability values for of the HMM for every time. It uses the probabilities of being in each state of the HMM from time t−1 to compute the probabilities of being in each state for time t. For each state at time t the forward probability of being in that state is computed by performing the summation of all of the probabilities of every path that could have been taken to reach that state from time t−1. A path probability is the state's forward probability at time t−1 multiplied by the probability of transitioning from that state to the current state multiplied by the probability that at time t the current state emitted the observed symbol. Each state may have forward probabilities computed for it at each time t. The largest probability found among any state at the final time may form the likelihood probability P(O|λ).

The following is a more formal description of the forward algorithm. The forward algorithm computes P(O=o₁, o₂, o₃, . . . o_{T}|λ). Each cell of the forward algorithm trellis αₜ(j) represents the probability of the HMM λ being in state j after seeing the first t observations. Each cell thus expresses the following probability:

αₜ(j)=P(o₁,o₂,o₃, . . . oₜ,qₜ=j|λ) [1.3]

Each αₜ(j) is computed with the following equation:

αₜ(j)=Σαₜ₋₁(i)=aᵢⱼ*bⱼ(oₜ); for 1≦i≦N, 1≦j≦N; 1≦t≦T [1.4]

where αₜ₋₁(i) denotes the forward probability of being in state j at time t−1, aᵢⱼ denotes the probability of transitioning from state i to state j, and bⱼ(oₜ) denotes the probability of emitting observation symbol oₜ when the HMM is in state j.

Solving Problem [2] Decoding:

The Viterbi Algorithm is a dynamic programming algorithm that is used by this invention to solve problem [2], the Decoding problem. The Viterbi Algorithm is very similar the Forward Algorithm. The main difference is that the probability of being in each state at every time t is not computed by performing the summation of all of the probabilities of every path that could have been taken to reach that state from the previous time. The probability of being in each state at each time t is computed by choosing the maximum path from time t−1 that could have led to that state at time t. Because these probabilities are not computed from summations of many path probabilities but by simply taking the path the produces the highest probability for that state, the Viterbi algorithm is a bit faster than the Forward Algorithm. However, because the Forward algorithm uses the summation of previous paths, it is more accurate. The Viterbi probability of a state at each time can be denoted with the following equation:

vₜ(j)=max[vₜ₋₁(i)*aᵢⱼ*bⱼ(oₜ)]; for 1≦i≦N, 1≦j≦N; 1≦t≦T [1.5]

The difference between the Forward Algorithm and the Viterbi Algorithm is that when each probability cell is computed in the Forward Algorithm it is done by computing a weighted sum of all of the previous time's cell's probabilities. In the Viterbi Algorithm, when each cell's probability is computed, it is done by only taking the maximum path from the previous time to that cell. At the final time there may be a cell in the trellis with the highest probability. The Viterbi Algorithm may back-trace to see which cell vₜ₋₁(j) lead to the cell at time t. This back-trace is done until the algorithm reaches the first cell v₁(j). Each vₜ₋₁(j) has a state j associated with it. By noting what these states are, the Viterbi Algorithm stores what the most probable hidden states are for the HMM λ for an observation sequence O. This solves the Decoding Problem

Solving Problem [1] Learning:

The only way HMMs can be used properly is if they are properly trained. Training HMMs solves problem [1], Learning. Training a HMM establishes the parameters of the HMM, namely the probabilities of transitioning to every state that the HMM has (the A matrix) and the probabilities that when in each state, the HMM may emit each symbol or vector of symbols (the B matrix). This invention uses two different training algorithms to solve the learning problem.

Solving Problem [1] using Baum-Welch Training:

The Baum-Welch algorithm is one algorithm that is used by this invention to perform this training. The Baum Welch algorithm in general takes as input a set of observation sequences of length T, an output vocabulary, a hidden state set, and noise. It may then compute the most probable parameters of the HMM iteratively. At first the HMM is given initial values as parameters. Then, during each iteration, an Expectation and Maximization Step occurs and the parameters of the HMM are progressively refined. These two steps, the Expectation and Maximization steps, are performed until the change in parameter values from one iteration until the next reaches the point where the rate of increase of the probability that the HMM generated the inputted observations becomes arbitrarily small. The Forward and Backward algorithms are used in the Baum-Welch computations.

Solving Problem [1] using Viterbi Training:

The Viterbi Training Algorithm is a second algorithm that is used by this invention to perform training. The following three steps are pseudocode for the Viterbi Training algorithm:

1. Make an initial estimate of the model, M=M⁰. Iterate the second
and third steps until the increase in L is arbitrarily small.
2. Using model M, execute the Viterbi algorithm on each of the
observation sets O¹, O², ..., O^{U}. Store the set of most likely state
sequence sets produced S¹, S², ... , S^{U}, and set

L=Σ P^{V}(O^{x} | M); for 1 ≦ x ≦ U
P^{V} denotes computing the probability by using the Viterbi
algorithm.

3. Use the Viterbi re-estimation equations [1.6] and [1.7] (below) to
generate a new M. The re-estimates are given by considering all the
sequences S¹, S², ... , S^{U} and setting the new parameters to be:

| | |
|---|---|
| aᵢⱼ = | [1.6] |
| (Number of transitions from state sᵢ to state sⱼ given the | |
| current model M) ÷ (Total number of transitions out of state sᵢ | |
| given the current model M) | |
| bⱼ(oₜ) = | [1.7] |
| (Number of emissions of symbol(s) o from state sⱼ given the | |
| current model M) ÷ (Total number of symbols emitted from state sⱼ | |
| given the current model M) | |

The subscript of t denotes the time within an observation set O^{x}. By filling in the re-estimated values of every aᵢⱼ in the A matrix and every bⱼ(oₜ) of the B matrix a new model M may be computed. New models are computed until the rate of change in L computed by each iteration becomes arbitrarily small.

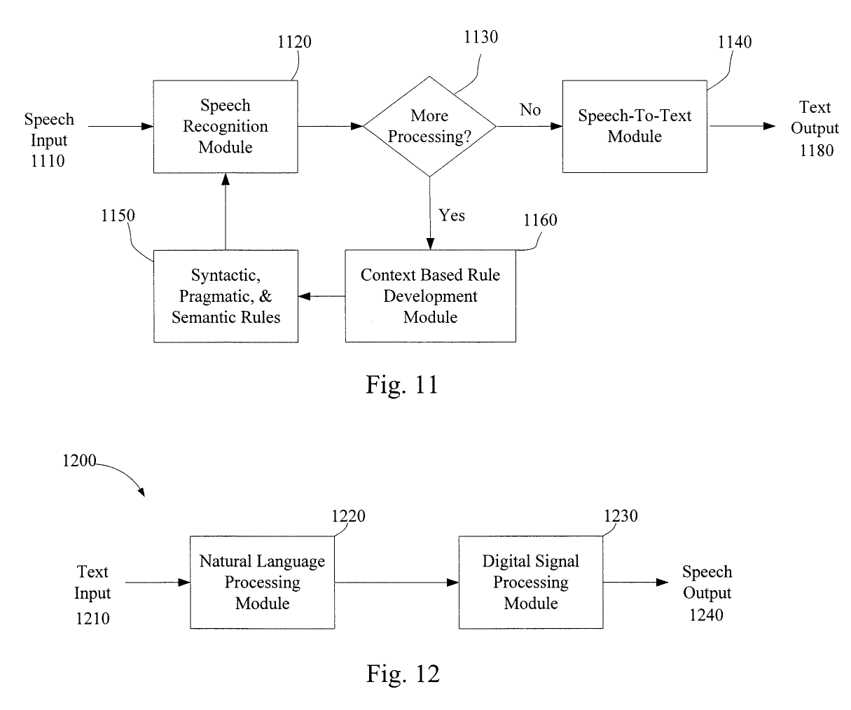

FIG. 11 illustrates a flow diagram another embodiment of a method for voice recognition. As illustrated, speech recognition module 1120 receives a input speech 1110. Processing within the speech recognition module 1120 may include various algorithms for SR and/or VR, including signal processing using spectral analysis to characterize the time-varying properties of the speech signal, pattern recognition using a set of algorithms to cluster data and create patterns, communication and information theory using methods for estimating parameters of statistical models to detect the presence of speech patterns, and/or other related models.

After initial processing, the speech recognition module 1120 may determine that more processing 1130 is needed. A context-based, rule development module 1160 may receive the initial interpretation provided by speech recognition module 1120. Often, the series of words are meaningful according to the syntax, semantics, and pragmatics (i.e., rules) of the input speech 1110. The context-based, rule development module 1160 may modify the rules (e.g., syntax, semantics, and pragmatics) according to the context of the words recognized. The rules, represented as syntactic, pragmatic, and/or semantic rules 1150, are provided to the speech recognition module 1120. The speech recognition module 1120 may also consult a database (not shown) of common words, phrases, mistakes, language specific idiosyncrasies, and other useful information. For example, the word “um” used in the English language when a speaker pauses may be removed during speech recognition.

Utilizing the developed rules 1150 and/or information from a database (not shown) of common terms, the speech recognition module 1120 is able to better recognize the input speech 1110. If more processing 1130 is needed, additional context based rules and other databases of information may be used to more accurately detect the input speech 1110. When processing is complete, speech-to-text module 1140 converts input speech 1110 to text output 1180. According to various embodiments, text output 1180 may be actual text or a machine representation of the same.

Speech recognition module 1120 may be configured as a speaker-dependent or speaker-independent device. Speaker-independent devices are capable of accepting input speech from any user. Speaker-dependent devices are trained to recognize input speech from particular users. A speaker-dependent voice recognition (VR) device typically operates in two phases, a training phase and a recognition phase. In a training phase, the VR system prompts the user to provide a speech sample to allow the system to learn the characteristics of the user's speech. For example, for a phonetic VR device, training is accomplished by reading one or more brief articles specifically scripted to include various phonemes in the language. The characteristics of the user's speech are then stored as VR templates. During operation, a VR device receives an unknown input from a user and accesses VR templates to find a match. Various alternative methods for VR exist, any number of which may be used with the presently described system.

FIG. 12 illustrates a model of an exemplary speech synthesizer. A speech synthesis module (or speech synthesizer) 1200 is a computer-based system that provides an audio output (i.e., synthesized output speech 1240) in response to a text or digital input 1210. The speech synthesizer 1200 provides automatic audio production of text input 1210. The speech synthesizer 1200 may include a natural language processing module 1220 and digital signal processing module 1230. Natural language processing module 1220 may receive a textual or other non-speech input 1210 and produce a phonetic transcription in response. Natural language processing 1220 may provide the desired intonation and rhythm (often termed as prosody) to digital signal processing module 1230, which transforms the symbolic information it receives into output speech 1240. Natural language processing 1220 involves organizing input sentences 1210 into manageable lists of words, identifying numbers, abbreviations, acronyms and idiomatic expressions, and transforming individual components into full text. Natural language processing 1220 may propose possible part of speech categories for each word taken individually, on the basis of spelling. Contextual analysis may consider words in their context to gain additional insight into probable pronunciations and prosody. Finally, syntactic-prosodic parsing is performed to find text structure. That is, the text input may be organized into clause and phrase-like constituents.

The term prosody refers to certain properties of the speech signal related to audible changes in pitch, loudness, and syllable length. For instance, there are certain pitch events which make a syllable stand out within an utterance, and indirectly the word or syntactic group it belongs to may be highlighted as an important or new component in the meaning of that utterance. Speech synthesis may consult a database of linguistic parameters to improve grammar and prosody.

Digital signal processing 1230 may produce audio output speech 1240 and is the digital analogue of dynamically controlling the human vocal apparatus. Digital signal processing 1230 may utilize information stored in databases for quick retrieval. According to one embodiment, the stored information represents basic sound units.

Additionally, such a database may contain frequently used words or phrases and may be referred to as a phonetic dictionary. A phonetic dictionary allows natural language processing module 1220 and digital signal processing module 1230 to organize basic sound units so as to correspond to text input 1210. The output speech 1240 may be in the voice of basic sound units stored within a phonetic dictionary (not shown). According to one embodiment of the present system and method, a user phonetic dictionary may be created in the voice of a user.

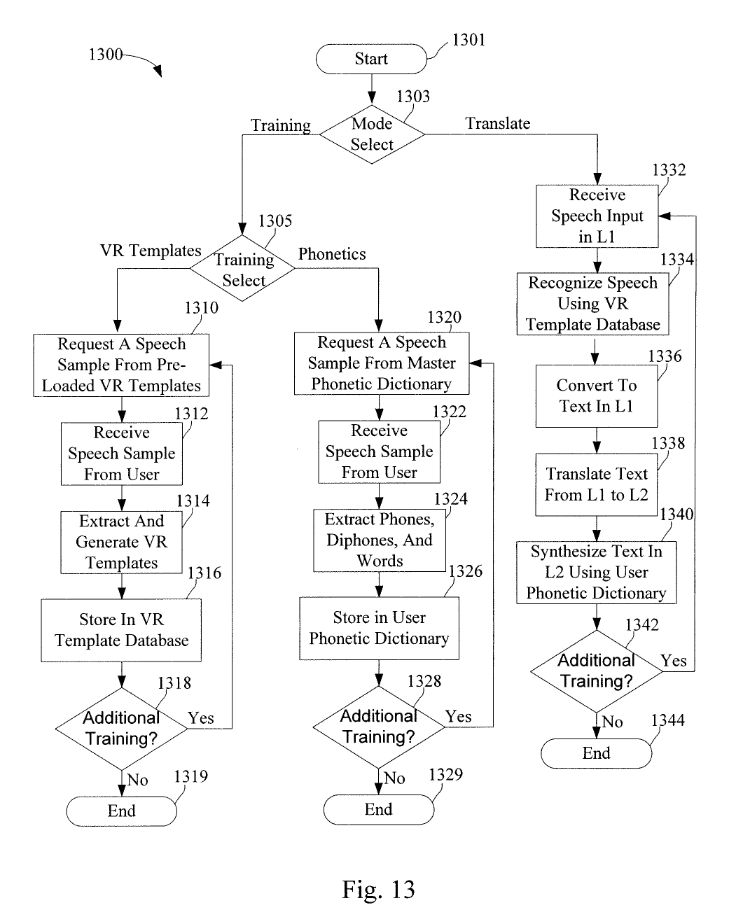

FIG. 13 illustrates an exemplary flow diagram for a method 300 performed by a speech-to-speech translation system, including a translation mode for translating speech from a first language to a second language and a training mode for building a voice recognition database and a user phonetic dictionary. Method 1300 includes a start 1301 where a user may be initially direct to elect a mode via mode select 1303. By electing ‘training,’ a further election between ‘VR templates’ and ‘phonetics’ is possible via training select 1305. By selecting ‘VR templates,’ a VR template database is developed specific to a particular user. The VR template database may be used by a speech recognition or VR module to recognize speech. As the VR template database is augmented with additional user specific VR templates, the accuracy of the speech recognition during translation mode may increase.

Returning to the VR templates training mode, selected via training select 1305, the system 1300 may request a speech sample from pre-loaded VR templates 1310. According to the illustrated embodiment, the system is a speaker-dependent voice recognition system. Consequently, in training mode, the VR system prompts a user to provide a speech sample corresponding to a known word, phrase, or sentence. For example, for a phonetic VR device, a training module may request a speech sample comprising one or more brief articles specifically scripted to include various basic sound units of a language. The speech sample is received 1312 by the system 1300. The system extracts and/or generates VR templates 314 from the received speech samples 1312. The VR templates are subsequently stored in a VR template database 1316. During translation mode, the VR template database may be accessed by a speech recognition or VR module to accurately identify input speech. If additional training 1318 is needed or requested by the user, the process begins again by requesting a speech sample from pre-loaded VR templates 1310. If ‘end’ is requested or training is complete, the process ends 1319.

Similarly, if training is selected via mode select 1303 and ‘phonetics’ is selected via training select 1305, a user phonetic dictionary may be created or augmented. As previously described, a finite number of phones, diphones, triphones, and other basic sound units exist for a given spoken language. A master phonetic dictionary (not shown) may contain a list of possible basic sound units. According to one exemplary embodiment, the list of basic sound units for a language is exhaustive; alternatively, the list may contain a sufficient number of basic sound units for speech synthesis. In the phonetics training mode, the method 1300 initially requests a speech sample from a master phonetic dictionary 1320.

A speech sample is received from a user 1322 corresponding to the requested speech sample 320. The system may extract phones, diphones, words, and/or other basic sound units 324 and store them in a user phonetic dictionary 1326. If additional training 1328 is needed or requested by the user, the system may again request a speech sample from a master phonetic dictionary 1320. If ‘end’ is requested or training is complete, the process ends 1329.

According to one embodiment, a training module requesting a speech sample from a master phonetic dictionary 1320 comprises a request by a system to a user including a pronunciation guide for desired basic sound units. For example, to obtain the basic sound units ‘gna’, ‘huh’, and ‘lo,’ the system may request a user enunciate the words ‘lasagna’, ‘hug’, and ‘loaf’, respectively, as speech samples. The system may receive speech sample 1322 and extract 1324 the desired basic sound units from each of the spoken words. In this manner, it is possible to initialize and/or augment a user phonetic dictionary in a language unknown to a user by requesting the enunciation of basic sound units in a known language. According to alternative embodiments, a user may be requested to enunciate words in an unknown language by following pronunciation guides.

Once a VR template database is sufficient for speech recognition and a user phonetic database is sufficient for speech synthesis, a translate mode may be selected via mode select 1303. According to alternative embodiments, translate mode may be selected prior to completing training, and pre-programmed databases may supplement user-specific databases. That is, VR may be performed using pre-loaded VR templates, and speech synthesis may result in a voice other than that of a user.

Returning to translate mode, input speech is received in a first language (L1) 332. The input speech is recognized 1334 by comparing the input speech with VR templates within a VR template database. Additionally, speech recognition may be performed by any of the various methods known in the art. The input speech in L1 is converted to text in L1 1336, or alternatively to a machine representation of the text in L1. The text in L1 is subsequently translated via a machine translation to text in a second language (L2) 1338. The text in L2 is transmitted to a synthesizer for speech synthesis. A speech synthesizer may access a user phonetic dictionary to synthesize the text in L2 to speech in L2 1340. Ultimately, the speech in L2 is directed to an output device for audible transmission. According to one embodiment, if additional speech 342 is detected, the process restarts by receiving input speech 1332; otherwise, the process ends 1344.

The presently described method provides a means whereby the synthesized speech in L2 1340 may be in the unique voice of the same user who provided the input speech in L1 1332. This is accomplished by using a user phonetic dictionary with basic sound units stored in the unique voice of a user. Basic sound units are concatenated to construct speech equivalent to text received from translator 1338. A synthesizer may utilize additional or alternative algorithms and methods known in the art of speech synthesis. A user phonetic dictionary containing basic sound units in the unique voice of a user allows the synthesized output speech in L2 to be in the unique voice of the user. Thus, a user may appear to be speaking a second language, even a language unknown to the user, in the user's actual voice. Additionally, linguistic parameter databases may be used to enhance the flow and prosody of the output speech.

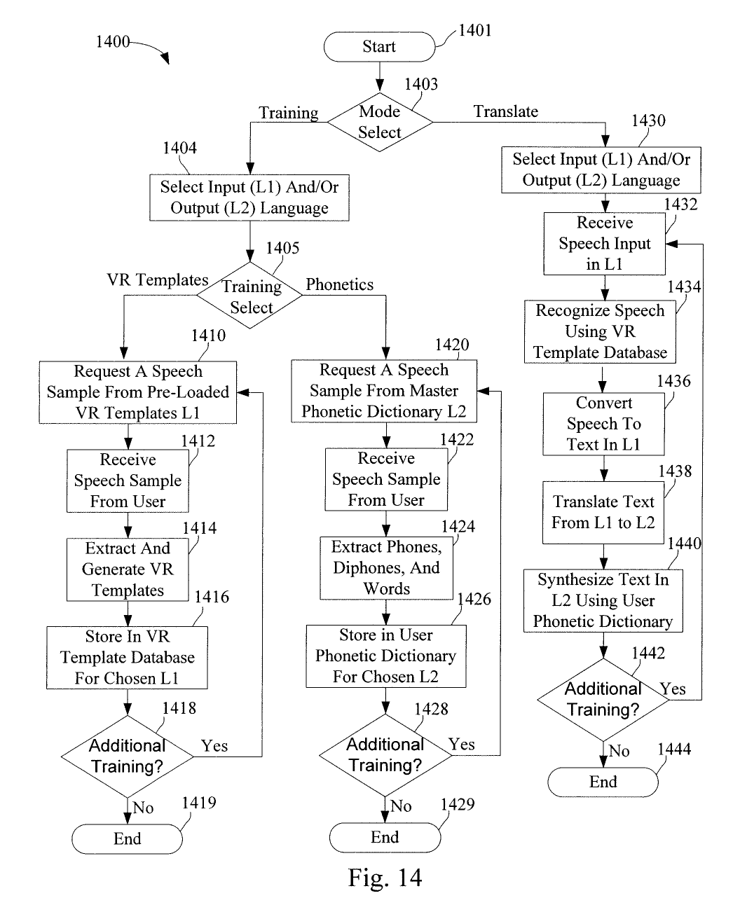

FIG. 14 illustrates an exemplary method 1400 performed by a speech-to-speech translation system. The illustrated method includes an option to select input, L1, and/or output, L2, languages. The method starts at 1401 and proceeds to a mode select 1403. A user may choose a training mode or a translation mode. After selecting a training mode via mode select 1403, a user may be prompted to select an input language, or L1, and/or and output language, or L2 1404. By selecting a language for L1, a user indicates in what language the user may enter speech samples, or in what language the user would like to augment a VR template database. By selecting a language for L2, a user indicates in what language the user would like the output speech, or in what language the user would like to augment a user phonetic dictionary. According to various embodiments, for each possible input and output language, a unique VR template database and a unique user phonetic dictionary are created. Alternatively, basic sound units and words common between two languages are shared between databases.

Once an input and/or output language has been selected 1404, a training mode is selected via training select 1405. A speech sample is requested corresponding to a pre-loaded VR template 1410 or to a master phonetic dictionary 1420, depending on whether ‘VR templates’ or ‘Phonetics’ were selected via training select 405. The speech sample is received 1412, 1422, VR templates or basic sound units are extracted and/or generated 1414, 1424, and the appropriate database or dictionary is augmented 1416, 1426. If additional training 1418, 1428 is needed or desired, the process begins again; otherwise, it ends 1419, 1429.

During mode select 1403, ‘translate’ may be chosen after which a user may select an input language L1, and/or and output language L2. According to various embodiments, only those options for L1 and L2 are provided for which corresponding VR template databases and/or user phonetic dictionaries exist. Thus, if only one language of VR templates has been trained or pre-programmed into a speech-to-speech translation system, then the system may use a default input language L1. Similarly, the output language may default to a single language for which a user phonetic dictionary has been created. However, if multiple user phonetic dictionaries exist, each corresponding to a different language, the user may be able to select from various output languages L2 1430. Once a L1 and L2 have been selected, or defaulted to, input speech is received in L1 from a user 1432. The speech is recognized by utilizing a VR template database 1434 and converted to text in L1 1436. The text in L1 is translated to text in L2 438 and subsequently transmitted to a synthesizer. According to various embodiments, the translation of the text and/or the synthesis of the text is aided by a linguistic parameter database. A linguistic parameter database may contain a dictionary useful in translating from one language to another and/or grammatical rules for one or more languages. The text in L2 is synthesized using a user phonetic dictionary corresponding to L2 1440.

Accordingly, and as previously described, the synthesized text may be in the voice of the user who originally provided input speech L1 432. According to various embodiments, if the user phonetic dictionary lacks sufficient training to contain all possible basic sound units, a user phonetic dictionary may be supplemented with generic, pre-programmed sound units from a master phonetic dictionary. If additional speech 442 is recognized, the process begins again by receiving a input speech in L1 432; otherwise, the process ends 444.

The above description provides numerous specific details for a thorough understanding of the embodiments described herein. However, those of skill in the art will recognize that one or more of the specific details may be omitted, or other methods, components, or materials may be used. In some cases, operations are not shown or described in detail. Specifically, VR and synthesis methods as used in the art may be adapted for use with the present disclosure to provide an output speech in the unique voice of a user.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

1. A speech-to-speech translation system comprising:
a processor;
an audio input device in electrical communication with the processor, the input device configured to receive audio input including an input speech sample of a user in a first language;
an audio output device in electrical communication with the processor, the audio output device configured to output audio including a translation of the input speech sample translated to a second language, wherein the output audio comprises basic sound units in the voice of the user; and
a computer-readable storage medium comprising:
a voice recognition module configured to receive the input speech sample and convert the input speech sample to text in the first language;
a translation module configured to translate the text in the first language to text in a second language; and
a speech synthesis module configured to receive the text in the second language and determine corresponding basic sound units in the voice of the user contained within a user phonetic dictionary to thereby generate speech in the second language in the unique voice of the user.

2. The translation system of claim 1, wherein the computer-readable storage medium further comprises a user dictionary initialization module configured to:
receive an input speech sample of a user speaking into the input device, extract one or more basic sound units from the input speech sample, and store a recording of the one or more basic sound units in the user phonetic dictionary, the basic sound units spoken in the voice of the user.

3. The translation system of claim 2, wherein the user dictionary initialization module stores a recording of the one or more basic sound units by storing a recording of the extracted basic sound units in a list of sounds and, for each word in the language, storing the basic sound units of the word in the user phonetic dictionary in association with the word.

4. The translation system of claim 3, wherein the basic sound units for each word are stored in the user phonetic dictionary in order by which the basic sounds are pronounced to speak the word.

5. The translation system of claim 4, wherein the order of the words is obtained from a master phonetic dictionary.

6. The translation system of claim 2, wherein the user phonetic dictionary contains all the words of a target language.

7. The translation system of claim 1, wherein the basic sound units are selected from the group consisting of phones, diphones, half-syllables, triphones, and words.

8. The translation system of claim 1, wherein the speech recognition module is configured to compare received input speech with a speech recognition template stored within a speech recognition database.

9. The translation system of claim 1, wherein speech recognition module further comprises a voice recognition module configured to recognize the user's unique voice from the input speech sample.

10. The translation system of claim 1, wherein the computer-readable storage medium further comprises an input/output language selection module configured to allow the selection of the first language and the selection of the second language.

11. The translation system of claim 1, wherein the computer-readable storage medium further comprises a training module configured to:
request a speech sample from the user, the speech sample derived from a master phonetic dictionary;
receive an input speech sample in a unique voice of the user;
generate a speech recognition template using the input speech sample; and
augment a speech recognition template database with the generated speech recognition template.

12. The translation system of claim 11, wherein the training module is further configured to:
extract a basic sound unit in the voice of the user from the input speech sample; and
store in the user phonetic dictionary the extracted basic sound unit in the unique voice.

13. The translation system of claim 1, wherein the audio input device comprises a microphone.

14. The translation system of claim 1, wherein the audio output device comprises one or more speakers.

15. A computer-implemented method for translating speech from a first language to a second language, the method comprising:
receiving an input speech sample on a computer system via an input device, the input speech sample spoken by a user in a first language;
the computer system recognizing the input speech sample in the first language;
the computer system converting the input speech sample in the first language to text in the first language;
the computer system translating the text in the first language to text in a second language;
the computer system synthesizing the text in the second language into speech in the second language by determining corresponding basic sound units within a user phonetic dictionary; and
the computer system generating an output of the speech in the second language in the unique voice.

16. The computer-implemented method of claim 15, further comprising the computer system initializing the user phonetic dictionary to contain basic unit sounds spoken in the voice of the user, including:
receiving on the computer system an input speech sample of the user speaking into an input device of the computer system,
extracting one or more basic sound units from the input speech sample, and
storing the one or more basic sound units in the user phonetic dictionary, the one or more basic sound units spoken in the voice of the user.

17. The computer-implemented method of claim 15, wherein the basic sound units are selected from the group consisting of phones, diphones, triphones, and words.

18. The computer-implemented method of claim 15, wherein recognizing the input speech sample in the first language comprises comparing a received input speech sample with a speech recognition template stored within a speech recognition template database.

19. The computer-implemented method of claim 18, wherein recognizing the input speech sample further comprises recognizing the user's unique voice from the input speech sample.

20. The computer-implemented method of claim 15, further comprising the steps of selecting a first language and selecting a second language.

21. The computer implemented method of claim 20, wherein the voice recognition template database is augmented through steps comprising:
the computer system requesting a speech sample from a pre-loaded voice recognition template;
the computer system receiving an input speech sample in a unique voice;
the computer system using the input speech sample to generate a voice recognition template; and
the computer system augmenting the voice recognition template database with the generated voice recognition template.

22. A system for translating speech from a first language to a second language, comprising:
means to receive a input speech in a first language in a unique voice;
means to convert the input speech in the first language to text in the first language;
means to translate the text in the first language to text in a second language;
means to synthesize the text in the second language into speech in the second language by determining corresponding basic sound units within a user phonetic dictionary;
means to output the speech in the second language in the unique voice.

23. The system of claim 22, further comprising means to augment the voice recognition template database comprising:
means to request a speech sample from the user, the speech sample derived from a master phonetic dictionary;
means to receive an input speech sample in a unique voice of the user;
means to generate a speech recognition template using the input speech sample; and
means to augment the speech recognition database with the generated speech recognition template.
